(19) United States
(12) Patent Application Publication
(10) Pub. No.: US 2025/0159355 A1
(43) Pub. Date: May 15, 2025

(54) CONTROL DEVICE, CONTROL METHOD, AND PROGRAM

(71) Applicant: FUJIFILM Corporation, Tokyo (JP)

(72) Inventor: Kazuchika IWAMI, Kanagawa (JP)

(73) Assignee: FUJIFILM Corporation, Tokyo (JP)

(21) Appl. No.: 19/021,107

(22) Filed: Jan. 14, 2025

Related U.S. Application Data
(63) Continuation of application No. PCT/JP2023/012978, filed on Mar. 29, 2023.

(30) Foreign Application Priority Data
Jul. 19, 2022 (JP) 2022-115112

(51) Int. Cl. H04N 23/71; B64U 20/87; H04N 23/72; H04N 23/73; H04N 23/75; H04N 23/76

(52) U.S. Cl. CPC H04N 23/71; H04N 23/72; H04N 23/73; H04N 23/75; H04N 23/76; B64U 20/87; B64U 2201/10

(57) ABSTRACT

A control device includes a first processor. The first processor is configured to acquire, at a time before a first moving object equipped with an imaging apparatus reaches a target position, brightness of an imaging target region imaged by the imaging apparatus from the target position, acquire a shutter speed corresponding to the brightness and a movement speed corresponding to the shutter speed, and cause, at the target position, the imaging apparatus to image the imaging target region with the shutter speed while causing the first moving object to move with the movement speed.

This application is a continuation application of International Application No. PCT/JP2023/012978, filed Mar. 29, 2023, the disclosure of which is incorporated herein by reference in its entirety. Further, this application claims priority under 35 USC 119 from Japanese Patent Application No. 2022-115112 filed Jul. 19, 2022, the disclosure of which is incorporated by reference herein.

### BACKGROUND OF THE INVENTION

### 1. Field of the Invention

The technology of the present disclosure relates to a control device, a control method, and a program.

### 2. Description of the Related Art

JP2021-96865A discloses an information processing apparatus that issues an instruction to control flight of a flying object. The information processing apparatus comprises a processing unit. The processing unit acquires an illuminance around the flying object, which is detected by an illuminance sensor provided in the flying object, and acquires relationship information indicating a relationship between the illuminance and an upper limit value of a flying speed of the flying object. The processing unit derives, based on the relationship information, the upper limit value of the flying speed of the flying object corresponding to the acquired illuminance, and issues the instruction to control the flying speed such that the flying speed is equal to or less than the upper limit value of the flying speed of the flying object.

JP2020-50261A discloses an information processing apparatus that issues an instruction to control flight of a flying object. The information processing apparatus comprises a processing unit. The processing unit acquires information of a shutter speed used by the flying object for imaging, and acquires information of a distance in a real space per pixel in a captured image captured by the flying object. The processing unit decides an upper limit value of a flying speed of the flying object based on the shutter speed and the distance in the real space per pixel, and issues the instruction to control the flying speed such that the flying speed is equal to or less than the upper limit value of the flying speed of the flying object.

WO2021/014752A discloses an information processing apparatus comprising a map creation unit, a shape extraction unit, a composition setting unit, and a route decision unit. The map creation unit creates a map of a movement range which is a range in which a moving object comprising an imaging apparatus performs imaging while moving. The shape extraction unit extracts a shape present in the map. The composition setting unit sets a composition of an image captured by the imaging apparatus. The route decision unit decides a movement route in the movement range of the moving object based on the shape and the composition.

JP2018-535487A discloses a method of controlling a movable object. The method includes a step of estimating, based on a target direction, a reference point of the movable object and one or a plurality of movement characteristics of the movable object at the reference point, and a step of generating, based on a position of the movable object and the one or the plurality of movement characteristics of the movable object at the reference point, a movement route of the movable object from the position of the movable object to the reference point thereof.

JP2019-507924A discloses a system that changes autonomous flight of an unmanned aerial vehicle (UAV). The system comprises a first user interface and a second user interface. The first user interface is configured to receive a first user input, and the first user input provides one or a plurality of commands for performing the autonomous flight of the UAV. The second user interface is configured to receive a second user input, and the second user input provides one or a plurality of commands for changing the autonomous flight of the UAV.

WO2018/167893A discloses a shape generation method. The shape generation method includes a step of acquiring information related to a plurality of imaging positions of a flying object having a plurality of imaging apparatuses. The shape generation method includes a step of selecting, from among the plurality of imaging apparatuses, an imaging apparatus used for imaging for each of the plurality of imaging positions. The shape generation method includes a step of performing the imaging by the imaging apparatus selected at each imaging position. The shape generation method includes a step of restoring, for each imaging apparatus, a shape of a subject based on a captured image. The shape generation method includes a step of compositing the shape restored for each imaging apparatus. The step of selecting the imaging apparatus includes a step of selecting at least one imaging apparatus from the plurality of imaging apparatuses based on a ratio of a portion having a predetermined light amount or less in an imaging region at the imaging position.

JP2019-87073A discloses a mobile manipulator comprising a moving device that moves from a first position to a second position, a manipulator connected to the moving device, a controller that controls the moving device and the manipulator, and an environment acquisition sensor that acquires environment data in association with a position of the moving device. The controller is configured to control at least any one of the moving device or the manipulator, based on the environment data that is acquired by the environment acquisition sensor and associated with a position of a movement destination or any point on a movement route between the first position and the second position.

### SUMMARY OF THE INVENTION

One embodiment according to the technology of the present disclosure provides, for example, a control device, a control method, and a program that can cause, at a target position, an imaging apparatus to image an imaging target region with a shutter speed corresponding to brightness of the imaging target region while causing a first moving object to move with a movement speed corresponding to the shutter speed.

A first aspect according to the technology of the present disclosure is a control device comprising a first processor, in which the first processor is configured to acquire, at a time before a first moving object equipped with an imaging apparatus reaches a target position, brightness of an imaging target region imaged by the imaging apparatus from the target position, acquire a shutter speed corresponding to the brightness and a movement speed corresponding to the shutter speed, and cause, at the target position, the imaging apparatus to image the imaging target region with the shutter speed while causing the first moving object to move with the movement speed.

A second aspect according to the technology of the present disclosure is the control device according to the first aspect, in which the first processor is configured to acquire the shutter speed corresponding to the brightness and the movement speed corresponding to the shutter speed, based on relationship information representing a relationship between the brightness, the shutter speed, and the movement speed.

A third aspect according to the technology of the present disclosure is the control device according to the second aspect, the control device further comprising a memory that stores the relationship information.

A fourth aspect according to the technology of the present disclosure is the control device according to any one of the first to third aspects, in which the brightness is detected from the target position by using a sensor.

A fifth aspect according to the technology of the present disclosure is the control device according to the fourth aspect, in which the sensor is mounted on a second moving object.

A sixth aspect according to the technology of the present disclosure is the control device according to the fifth aspect, in which the target position is set on a movement route, and the brightness is detected while the second moving object moves on the movement route with a speed higher than the movement speed.

A seventh aspect according to the technology of the present disclosure is the control device according to any one of the first to third aspects, in which the brightness is detected by using a bird's-eye view camera that views a subject including the imaging target region from above.

An eighth aspect according to the technology of the present disclosure is the control device according to the seventh aspect, in which the subject includes a plurality of the imaging target regions.

A ninth aspect according to the technology of the present disclosure is the control device according to any one of the first to eighth aspects, in which the target position is set on a movement route, and the brightness is detected at a time before the first moving object starts moving along the movement route.

A tenth aspect according to the technology of the present disclosure is the control device according to any one of the first to eighth aspects, in which the target position is set on a movement route, and the brightness is detected at a time before the first moving object reaches the target position after the first moving object starts moving along the movement route.

An eleventh aspect according to the technology of the present disclosure is the control device according to any one of the first to tenth aspects, in which a plurality of the target positions are set as movement destinations to which the first moving object moves, and the first processor is configured to cause, at the plurality of target positions, the imaging apparatus to image the imaging target region with a constant F number.

A twelfth aspect according to the technology of the present disclosure is the control device according to any one of the first to tenth aspects, in which a plurality of the target positions are set as movement destinations to which the first moving object moves, and the first processor is configured to cause, for each target position, the imaging apparatus to image the imaging target region with an F number corresponding to the brightness and/or the shutter speed.

A thirteenth aspect according to the technology of the present disclosure is the control device according to any one of the first to twelfth aspects, in which a plurality of the target positions are set as movement destinations to which the first moving object moves, the first processor is configured to acquire, for each target position, an image for composition obtained by causing the imaging apparatus to image the imaging target region, and the image for composition is an image in which the images for composition adjacent to each other partially overlap each other.

A fourteenth aspect according to the technology of the present disclosure is the control device according to the thirteenth aspect, the control device further comprising a second processor that composites the images for composition adjacent to each other to generate a composite image, in which the second processor is configured to perform specific processing on the composite image based on the brightness.

A fifteenth aspect according to the technology of the present disclosure is the control device according to the fourteenth aspect, in which the specific processing includes correction processing of correcting brightness of the composite image.

A sixteenth aspect according to the technology of the present disclosure is the control device according to the fifteenth aspect, in which the correction processing includes processing of correcting a difference in the brightness between the images for composition.

A seventeenth aspect according to the technology of the present disclosure is the control device according to the fifteenth or sixteenth aspect, in which the correction processing includes processing of correcting a brightness distribution of the composite image based on a distribution of the brightness.

An eighteenth aspect according to the technology of the present disclosure is the control device according to any one of the fourteenth to seventeenth aspects, in which the specific processing includes notification processing of performing notification in a case where a difference in the brightness between the imaging target regions exceeds a default value.

A nineteenth aspect according to the technology of the present disclosure is a control method comprising acquiring, at a time before a first moving object equipped with an imaging apparatus reaches a target position, brightness of an imaging target region imaged by the imaging apparatus from the target position, acquiring a shutter speed corresponding to the brightness and a movement speed corresponding to the shutter speed, and causing, at the target position, the imaging apparatus to image the imaging target region with the shutter speed while causing the first moving object to move with the movement speed.

A twentieth aspect according to the technology of the present disclosure is a program causing a computer to execute a process comprising acquiring, at a time before a first moving object equipped with an imaging apparatus reaches a target position, brightness of an imaging target region imaged by the imaging apparatus from the target position, acquiring a shutter speed corresponding to the brightness and a movement speed corresponding to the shutter speed, and causing, at the target position, the imaging apparatus to image the imaging target region with the shutter speed while causing the first moving object to move with the movement speed.

### BRIEF DESCRIPTION OF THE DRAWINGS

FIG. 1 is a front view of an example of a plurality of imaging target regions and an imaging system according to a first embodiment.

FIG. 2 is a block diagram showing an example of a hardware configuration of a flight imaging apparatus according to the first embodiment.

FIG. 3 is a block diagram showing a hardware configuration of an imaging apparatus according to the first embodiment.

FIG. 4 is a block diagram showing an example of a functional configuration for realizing flight imaging processing according to the first embodiment.

FIG. 5 is a descriptive diagram for describing an example of operations of a data request unit and a brightness acquisition unit according to the first embodiment.

FIG. 6 is a descriptive diagram for describing an example of operations of the brightness acquisition unit and an imaging condition acquisition unit according to the first embodiment.

FIG. 7 is a descriptive diagram for describing an example of operations of the imaging condition acquisition unit and a flying speed control unit according to the first embodiment.

FIG. 8 is a descriptive diagram describing an example of operations of the imaging condition acquisition unit, a reach determination unit, and an imaging control unit according to the first embodiment.

FIG. 9 is a flowchart showing an example of a flow of the flight imaging processing according to the first embodiment.

FIG. 10 is a descriptive diagram for describing an example of operations of the data request unit and the brightness acquisition unit according to a second embodiment.

FIG. 11 is a descriptive diagram for describing an example of operations of the data request unit and the brightness acquisition unit according to a third embodiment.

FIG. 12 is a descriptive diagram for describing an example of operations of the data request unit and the brightness acquisition unit according to a fourth embodiment.

FIG. 13 is a block diagram showing an example of a functional configuration for realizing composite image generation processing according to a fifth embodiment.

FIG. 14 is a descriptive diagram for describing an example of operations of an image composition unit, a brightness information acquisition unit, and a correction processing unit according to the fifth embodiment.

FIG. 15 is a flowchart showing an example of a flow of the composite image generation processing according to the fifth embodiment.

### DESCRIPTION OF THE PREFERRED EMBODIMENTS

Hereinafter, an example of embodiments of a control device, a control method, and a program according to the technology of the present disclosure will be described with reference to accompanying drawings.

First, terms used in the following description will be described.

I/F refers to an abbreviation for “interface”. RAM refers to an abbreviation for “random access memory”. CPU refers to an abbreviation for “central processing unit”. GPU refers to an abbreviation for “graphics processing unit”. HDD refers to an abbreviation for “hard disk drive”. SSD refers to an abbreviation for “solid state drive”. DRAM refers to an abbreviation for “dynamic random access memory”. SRAM refers to an abbreviation for “static random access memory”. GNSS refers to an abbreviation for “global navigation satellite system”. GPS refers to an abbreviation of “global positioning system”. LiDAR refers to an abbreviation for “light detection and ranging”. NVM indicates the abbreviation for “non-volatile memory”. ASIC refers to an abbreviation for “application specific integrated circuit”. FPGA refers to an abbreviation for “field-programmable gate array”. PLD refers to an abbreviation for “programmable logic device”. CMOS refers to an abbreviation for “complementary metal oxide semiconductor”. CCD refers to an abbreviation for “charge coupled device”. RGB refers to an abbreviation for “red green blue”. CIE refers to an abbreviation for “Commission Internationale de l'Eclairage”. TPU refers to an abbreviation for “tensor processing unit”. USB refers to an abbreviation for “universal serial bus”. SoC refers to an abbreviation of a “system-on-a-chip”. IC refers to an abbreviation for “integrated circuit”.

In the description of the present specification, a term “vertical direction” refers to, in addition to a complete vertical direction, a vertical direction generally allowed in the technical field to which the technology of the present disclosure belongs, the vertical direction in a sense of including an error to the extent that the error does not contradict the gist of the technology of the present disclosure. In the description of the present specification, a term “horizontal direction” refers to, in addition to a complete horizontal direction, a horizontal direction generally allowed in the technical field to which the technology of the present disclosure belongs, the horizontal direction in a sense of including an error to the extent that the error does not contradict the gist of the technology of the present disclosure. In the description of the present specification, a term “quadrangle” refers to, in addition to a complete quadrangle, a quadrangle generally allowed in the technical field to which the technology of the present disclosure belongs, the quadrangle in a sense of including an error to the extent that the error does not contradict the gist of the technology of the present disclosure. In the description of the present specification, a term “perpendicular” refers to, in addition to a complete perpendicular, a perpendicular generally allowed in the technical field to which the technology of the present disclosure belongs, the perpendicular in a sense of including an error to the extent that the error does not contradict the gist of the technology of the present disclosure. In the description of the present specification, a term “being constant” refers to, in addition to being completely constant, being constant generally allowed in the technical field to which the technology of the present disclosure belongs, the being constant in a sense of including an error to the extent that the error does not contradict the gist of the technology of the present disclosure.

### First Embodiment

First, a first embodiment will be described.

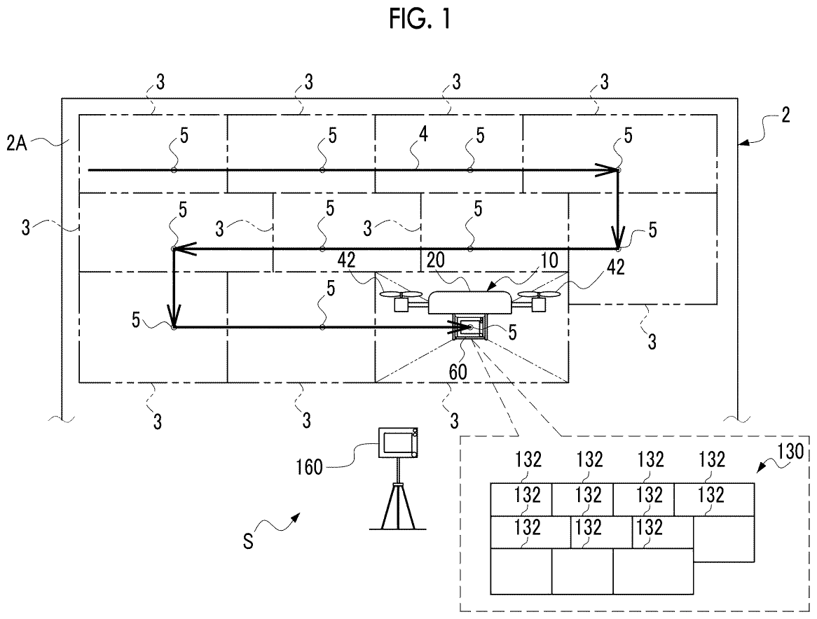

As shown in FIG. 1 as an example, an imaging system S comprises a flight imaging apparatus 10 and a bird's-eye view camera 160. The flight imaging apparatus 10 has a flight function and an imaging function, and images a wall surface 2A of an object 2 while the flight imaging apparatus 10 flies.

The wall surface 2A is a plane as an example. The plane refers to a two-dimensional surface (that is, surface along a two-dimensional direction). Further, in the description of the present specification, the concept of “plane” does not include the meaning of a mirror surface. In the present embodiment, for example, the wall surface 2A is a plane defined in a horizontal direction and a vertical direction (that is, surface extending in the horizontal direction and the vertical direction). The wall surface 2A has unevenness. The unevenness referred to here includes, for example, unevenness associated with a defect and/or a deficiency, in addition to unevenness due to a material forming the wall surface 2A. As an example, the object 2 having the wall surface 2A is a pier provided in a bridge. The pier is made of, for example, reinforced concrete. Here, the pier is exemplified as an example of the object 2, but the object 2 may be an object (for example, tunnel or dam) other than the pier.

The flight imaging apparatus 10 comprises a flying object 20 and an imaging apparatus 60. The flying object 20 is, for example, an unmanned aerial vehicle such as a drone. The flight function of the flight imaging apparatus 10 is realized by the flying object 20. The flying object 20 includes a plurality of propellers 42, and causes the plurality of propellers 42 to rotate to fly. The flying of the flying object 20 is synonymous with the flying of the flight imaging apparatus 10. The flying object 20 is an example of “moving object” according to the technology of the present disclosure.

The imaging apparatus 60 is, for example, a digital camera or a video camera. The imaging function of the flight imaging apparatus 10 is realized by the imaging apparatus 60. The imaging apparatus 60 is mounted on the flying object 20. As an example, the imaging apparatus 60 is provided below the flying object 20. The imaging apparatus 60 is an example of “imaging apparatus” according to the technology of the present disclosure.

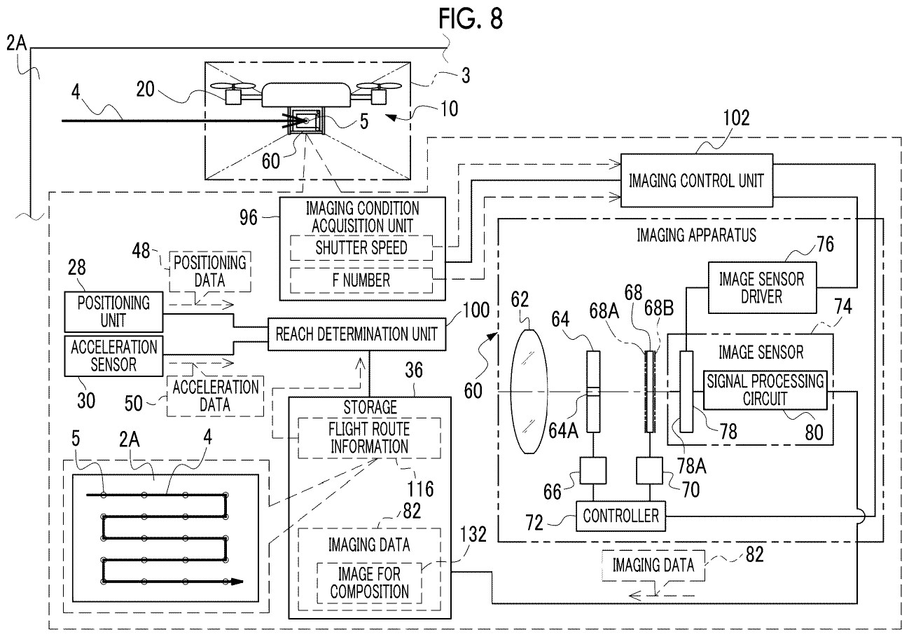

A flight route 4 is set for the object 2. In the example shown in FIG. 1, the flight route 4 is set on a virtual surface facing the wall surface 2A. As an example, the flight route 4 is set in a zigzag shape in which a horizontal route extending in the horizontal direction and a vertical route extending in the vertical direction are connected. The flight imaging apparatus 10 stores flight route information 116 (refer to FIG. 8) indicating the flight route 4 as described below, and can autonomously fly along the flight route 4 without depending on a flight instruction signal from a transmitter (not shown), a base station (not shown), or the like.

The flight imaging apparatus 10 moves in a zigzag manner by alternately repeating movement in the horizontal direction and movement in the vertical direction in flying along the flight route 4. A plurality of waypoints 5 are set on the flight route 4. At each waypoint 5, the flight imaging apparatus 10 images the wall surface 2A. The flight route 4 is an example of “movement route” according to the technology of the present disclosure, and the waypoint 5 is an example of “target position” according to the technology of the present disclosure.

Here, an example is exemplified in which the flight imaging apparatus 10 autonomously flies along the flight route 4. However, the flight imaging apparatus 10 may fly along the flight route 4 based on the flight instruction signal from a transmitter, a base station, or the like.

The flight imaging apparatus 10 images the wall surface 2A at each waypoint 5 to sequentially image a plurality of imaging target regions 3 on the wall surface 2A. Each imaging target region 3 corresponds to each waypoint 5. The imaging target region 3 is a region determined by an angle of view of the flight imaging apparatus 10. The example shown in FIG. 1 shows a quadrangular region as an example of the imaging target region 3. With the movement of the flight imaging apparatus 10 in the zigzag shape by alternately repeating the movement in the horizontal direction and the movement in the vertical direction, the plurality of imaging target regions 3 that are connected in a zigzag shape are sequentially imaged.

With the sequential imaging of the plurality of imaging target regions 3 by the imaging apparatus 60, a plurality of images for composition 132 are obtained. The plurality of images for composition 132 are composited to generate a composite image 130. The plurality of images for composition 132 are composited such that the images for composition 132 adjacent to each other partially overlap each other. An example of the composite image 130 includes a two-dimensional panoramic image. The two-dimensional panoramic image is merely an example, and a three-dimensional image (for example, three-dimensional panoramic image) may be generated as the composite image 130 in the same manner as the two-dimensional panoramic image is generated as the composite image 130.

The composite image 130 may be generated each time each image for composition 132 is obtained from a second frame and subsequent frames, or may be generated after the plurality of images for composition 132 are obtained for the wall surface 2A. Further, processing of generating the composite image 130 may be executed by the flight imaging apparatus 10, or may be executed by an external apparatus (not shown) that is communicably connected to the flight imaging apparatus 10. The composite image 130 is used, for example, to inspect or survey the wall surface 2A of the object 2.

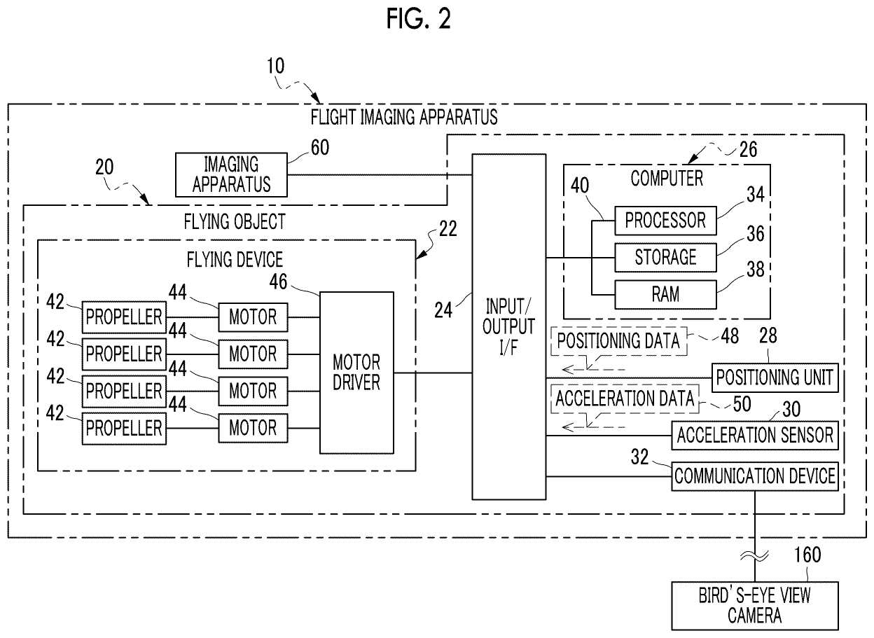

The example shown in FIG. 1 shows an aspect in which the imaging apparatus 60 images each imaging target region 3 in a state in which an optical axis OA (refer to FIG. 2) of the imaging apparatus 60 is perpendicular to the wall surface 2A. Hereinafter, an example will be described in which the imaging apparatus 60 images each imaging target region 3 in a state where the optical axis OA of the imaging apparatus 60 is perpendicular to the wall surface 2A.

The plurality of imaging target regions 3 are imaged such that the imaging target regions 3 adjacent to each other partially overlap each other. The imaging of the plurality of imaging target regions 3 such that the imaging target regions 3 adjacent to each other partially overlap each other is performed to composite the images for composition 132 corresponding to the imaging target regions 3 adjacent to each other based on feature points included in an overlapping portion of the imaging target regions 3 adjacent to each other. Hereinafter, each of the partial overlapping of the imaging target regions 3 adjacent to each other and the partial overlapping of the images for composition 132 adjacent to each other may be referred to as “overlap”.

The bird's-eye view camera 160 is a digital camera or a video camera having a wider angle than the imaging apparatus 60. The bird's-eye view camera 160 is disposed, for example, to face the wall surface 2A. Further, the bird's-eye view camera 160 is installed at a position farther from the wall surface 2A than the flight imaging apparatus 10. The bird's-eye view camera 160 has the angle of view capable of imaging the entire wall surface 2A. The bird's-eye view camera 160 comprises an imaging lens, an image sensor, a processor, a storage, a RAM, and the like, although not shown. The bird's-eye view camera 160 is an example of “bird's-eye view camera” according to the technology of the present disclosure.

As shown in FIG. 2 as an example, the flying object 20 comprises a flying device 22, an input/output I/F 24, a computer 26, a positioning unit 28, an acceleration sensor 30, and a communication device 32. The computer 26 is an example of “control device” and “computer” according to the technology of the present disclosure.

The computer 26 comprises a processor 34, a storage 36, and a RAM 38. The processor 34, the storage 36, and the RAM 38 are connected to each other via a bus 40, and the bus 40 is connected to the input/output I/F 24. Further, the positioning unit 28, the acceleration sensor 30, and the communication device 32 are also connected to the input/output I/F 24.

The processor 34 includes, for example, a CPU, and controls the entire flight imaging apparatus 10. Here, an example is exemplified in which the processor 34 includes the CPU, but this is merely an example. For example, the processor 34 may include the CPU and a GPU. In this case, for example, the GPU operates under control of the CPU, and is responsible for executing image processing. The processor 34 is an example of “first processor” according to the technology of the present disclosure.

The storage 36 is a nonvolatile storage device that stores various programs, various parameters, and the like. Examples of the storage 36 include an HDD and an SSD. The HDD and the SSD are merely examples. Instead of the HDD and/or the SSD or together with the HDD and/or the SSD, a flash memory, a magnetoresistive memory, and/or a ferroelectric memory may be used.

The RAM 38 is a memory where information is temporarily stored, and is used as a work memory by the processor 34. Examples of the RAM 38 include a DRAM and/or an SRAM.

The communication device 32 is communicably connected to the bird's-eye view camera 160 by wire or wirelessly. The communication device 32 controls information exchange with the bird's-eye view camera 160. For example, the communication device 32 transmits, to the bird's-eye view camera 160, information in response to a request from the processor 34. Further, the communication device 32 receives data transmitted from the bird's-eye view camera 160 and outputs the received data to the processor 34 via the bus 40.

The flying device 22 includes the plurality of propellers 42, a plurality of motors 44, and a motor driver 46. The motor driver 46 is connected to the processor 34 via the input/output I/F 24 and the bus 40. The motor driver 46 individually controls the plurality of motors 44 in accordance with an instruction from the processor 34. The number of the plurality of motors 44 is the same as the number of the plurality of propellers 42.

The propeller 42 is fixed to a rotating shaft of each motor 44. Each motor 44 causes the propeller 42 to rotate. With the rotation of the plurality of propellers 42, the flying object 20 flies. The number of the plurality of propellers 42 (in other words, the number of the plurality of motors 44) provided in the flying object 20 is four as an example, but this is merely an example. For example, the number of the plurality of propellers 42 may be three, or five or more.

The positioning unit 28 is a device that detects a position of the flying object 20. The position of the flying object 20 is detected using, for example, GNSS (for example, GPS). The positioning unit 28 includes a GNSS receiver (not shown). The GNSS receiver receives, for example, radio waves transmitted from a plurality of satellites. The positioning unit 28 detects the position of the flying object 20 based on the radio wave received by the GNSS receiver, and outputs positioning data 48 (for example, data indicating latitude, longitude, and altitude) according to the detected position.

The acceleration sensor 30 detects an acceleration of the flying object 20 in each axial direction of a pitch axis, a yaw axis, and a roll axis. The acceleration sensor 30 outputs acceleration data 50 according to the acceleration of the flying object 20 in each axial direction. The processor 34 acquires the position of the flying object 20 based on the positioning data 48 and/or the acceleration data 50.

In a case where the processor 34 acquires the position of the flying object 20 based on only the positioning data 48, the acceleration sensor 30 may be omitted. On the other hand, in a case where the processor 34 acquires the position of the flying object 20 based on only the acceleration data 50, the positioning unit 28 may be omitted.

In a case where the processor 34 acquires the position of the flying object 20 based on the positioning data 48, a position thereof in an absolute coordinate system is derived based on the positioning data 48. On the other hand, in a case where the processor 34 acquires an imaging position based on the acceleration data 50, an amount of change in the position with respect to a reference position determined in a relative coordinate system is derived based on the acceleration data 50.

Further, the flying object 20 may comprise another device that detects the position of the flying object 20, instead of the positioning unit 28 and/or the acceleration sensor 30 or in addition to the positioning unit 28 and/or the acceleration sensor 30. Examples of another device include a LiDAR scanner, a stereo camera, a magnetic compass, an atmospheric pressure altimeter, and an ultrasonic sensor.

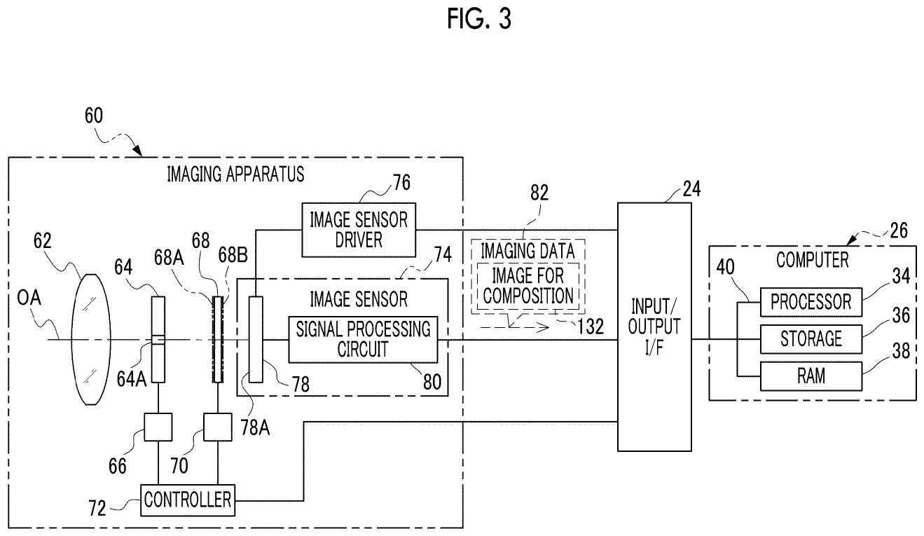

As shown in FIG. 3 as an example, the imaging apparatus 60 comprises an imaging lens 62, a stop 64, a stop actuator 66, a mechanical shutter 68, a shutter actuator 70, a controller 72, an image sensor 74, and an image sensor driver 76.

The controller 72 and the image sensor driver 76 are connected to the processor 34 via the input/output I/F 24 and the bus 40. The imaging lens 62 includes, for example, an objective lens (not shown) and a focus lens (not shown). Further, the imaging apparatus 60 includes a zoom lens (not shown). The imaging lens 62 is disposed on an object side with respect to the stop 64, and the zoom lens is disposed between the stop 64 and the mechanical shutter 68.

The stop actuator 66 has a power transmission mechanism (not shown) and a motor for stop (not shown). The stop 64 has an opening 64A, and a size of the opening 64A is variable. The opening 64A is formed by a plurality of blades (not shown). The plurality of blades are linked to the power transmission mechanism. The motor for stop is connected to the power transmission mechanism, and the power transmission mechanism transmits power of the motor for stop to the plurality of blades. The plurality of blades operate by receiving the power transmitted from the power transmission mechanism to change the size of the opening 64A. The stop 64 changes the size of the opening 64A to adjust an exposure. An F number is defined by the size of the opening 64A. The stop actuator 66 is connected to the controller 72.

The controller 72 is a device having, for example, a computer including a CPU, an NVM, and a RAM, although not shown. Here, the computer is illustrated, but this is merely an example. A device including an ASIC, an FPGA, and/or a PLD may be employed. Further, for example, a device implemented by a combination of a hardware configuration and a software configuration may be used as the controller 72. The controller 72 controls the stop actuator 66 in accordance with the instruction from the processor 34.

The image sensor 74 comprises a photoelectric conversion element 78 and a signal processing circuit 80. The image sensor 74 is a CMOS image sensor as an example. In the present embodiment, the CMOS image sensor is illustrated as the image sensor 74, but the technology of the present disclosure is not limited thereto. For example, the technology of the present disclosure is also established in a case where the image sensor 74 is an image sensor of another type such as a CCD image sensor. The photoelectric conversion element 78 is connected to the image sensor driver 76. The image sensor driver 76 controls the photoelectric conversion element 78 in accordance with the instruction from the processor 34.

The photoelectric conversion element 78 has a light-receiving surface 78A on which a plurality of pixels (not shown) are provided. The photoelectric conversion element 78 outputs electric signals output from the plurality of physical pixels to the signal processing circuit 80 as imaging data 82. The signal processing circuit 80 converts the analog imaging data 82 input from the photoelectric conversion element 78 into a digital form. The signal processing circuit 80 is connected to the input/output I/F 24. The digitized imaging data 82 indicates the image for composition 132, and is subjected to various types of processing by the processor 34 and then stored in the storage 36.

The mechanical shutter 68 is a focal plane shutter as an example, and is disposed between the stop 64 and the light-receiving surface 78A. The mechanical shutter 68 comprises a front curtain 68A and a rear curtain 68B. As an example, each of the front curtain 68A and the rear curtain 68B comprises a plurality of blades (not shown). The front curtain 68A is disposed closer to a subject side than the rear curtain 68B.

The shutter actuator 70 has a link mechanism (not shown), a solenoid for front curtain (not shown), and a solenoid for rear curtain (not shown). The solenoid for front curtain is a drive source for the front curtain 68A, and is mechanically linked to the front curtain 68A via the link mechanism. The solenoid for rear curtain is a drive source for the rear curtain 68B, and is mechanically linked to the rear curtain 68B via the link mechanism. The shutter actuator 70 is connected to the controller 72. The controller 72 controls the shutter actuator 70 in accordance with the instruction from the processor 34.

The solenoid for front curtain generates the power under the control of the controller 72, and applies the generated power to the front curtain 68A to selectively perform winding-up and pulling-down of the front curtain 68A. The solenoid for rear curtain generates the power under the control of the controller 72, and applies the generated power to the rear curtain 68B to selectively perform the winding-up and the pulling-down of the rear curtain 68B. In the imaging apparatus 60, opening and closing of the front curtain 68A and opening and closing of the rear curtain 68B are controlled by the processor 34 to adjust an exposure amount with respect to the image sensor 74. Further, a shutter speed of the mechanical shutter 68 is defined by a time for which the front curtain 68A and the rear curtain 68B are open.

Here, the focal plane shutter has been described as an example of the mechanical shutter 68, but this is merely an example. The mechanical shutter 68 may be a lens shutter. Further, an example has been described in which the shutter speed of the mechanical shutter 68 is derived and set, but this is merely an example. For example, the shutter speed of an electronic shutter (for example, electronic front curtain shutter or fully electronic shutter) may be derived and set in the same manner as described above.

Further, in the examples shown in FIGS. 2 and 3, the computer 26 common to the flying object 20 and the imaging apparatus 60 is used. However, the computer 26 may be configured by a first computer provided in the flying object 20 and a second computer provided in the imaging apparatus 60. The computer 26 is mounted on the flying object 20, but may be mounted on the imaging apparatus 60. Further, the computer 26 may be mounted on a transmitter or a base station. An example of a hardware configuration of the flight imaging apparatus 10 has been described above.

Subsequently, problems of the first embodiment will be described. As a technology of causing the imaging apparatus 60 to image the imaging target region 3 corresponding to the target waypoint 5 in a case where the flying object 20 on which the imaging apparatus 60 is mounted reaches the waypoint 5 to be targeted (hereinafter referred to as “target waypoint 5”), the following technology is assumed.

That is, in the technology to be assumed (hereinafter referred to as “assumed technology”), the imaging apparatus 60 images a region corresponding to a flying position of the flying object 20 (hereinafter referred to as “flying position corresponding region”) at a time before the flying object 20 reaches the target waypoint 5, and a brightness of the flying position corresponding region is detected based on an image obtained by the imaging. Subsequently, the shutter speed corresponding to the detected brightness and a flying speed corresponding to the shutter speed are calculated. At the target waypoint 5, the imaging apparatus 60 images the imaging target region 3 at the calculated shutter speed while the flying object 20 flies at the calculated flying speed.

In the assumed technology, the imaging apparatus 60 images the flying position corresponding region at the time before the flying object 20 reaches the target waypoint 5, and the brightness of the flying position corresponding region is detected based on the image obtained by the imaging. The flying position corresponding region imaged by the imaging apparatus 60 is a region at a position in front of the imaging target region 3 corresponding to the target waypoint 5. Therefore, the flying position corresponding region imaged by the imaging apparatus 60 may have a different brightness from the imaging target region 3 corresponding to the target waypoint 5. In a case where the brightness of the flying position corresponding region and the brightness of the imaging target region 3 are different as described above, the imaging target region 3 cannot be imaged at the shutter speed corresponding to the brightness of the imaging target region 3.

In order to image the imaging target region 3 at the shutter speed corresponding to the brightness of the imaging target region 3, the following correspondence method is considered. That is, a correspondence method is considered in which the flying object 20 is in a state of being temporarily stopped at the target waypoint 5 in a case where the flying object 20 reaches the target waypoint 5 and the brightness of the imaging target region 3 is detected, based on the image obtained by imaging the imaging target region 3 with the imaging apparatus 60 in this state, to calculate the shutter speed corresponding to the detected brightness.

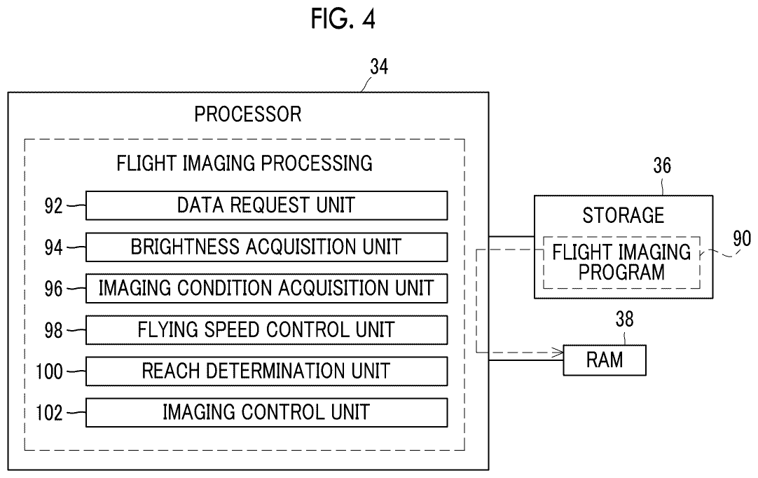

However, in the above correspondence method, since the flying object 20 is temporarily stopped at the target waypoint 5, there is a problem of not being capable of causing the imaging apparatus 60 to image the imaging target region 3 while the flying object 20 is caused to fly. In the first embodiment, at the target waypoint 5, the imaging apparatus 60 is caused to image the imaging target region 3 at the shutter speed corresponding to the brightness of the imaging target region 3 while the flying object 20 is caused to fly at the flying speed corresponding to the shutter speed. In order to realize the above, in the first embodiment, the processor 34 performs flight imaging processing (refer to FIGS. 4 to 9) described below.

As shown in FIG. 4 as an example, the storage 36 stores a flight imaging program 90. The processor 34 reads out the flight imaging program 90 from the storage 36, and executes the readout flight imaging program 90 on the RAM 38. The processor 34 performs the flight imaging processing for imaging the imaging target region 3 while the flight imaging apparatus 10 flies, in accordance with the flight imaging program 90 executed on the RAM 38. The flight imaging processing is realized by the processor 34 operating as a data request unit 92, a brightness acquisition unit 94, an imaging condition acquisition unit 96, a flying speed control unit 98, a reach determination unit 100, and an imaging control unit 102, in accordance with the flight imaging program 90.

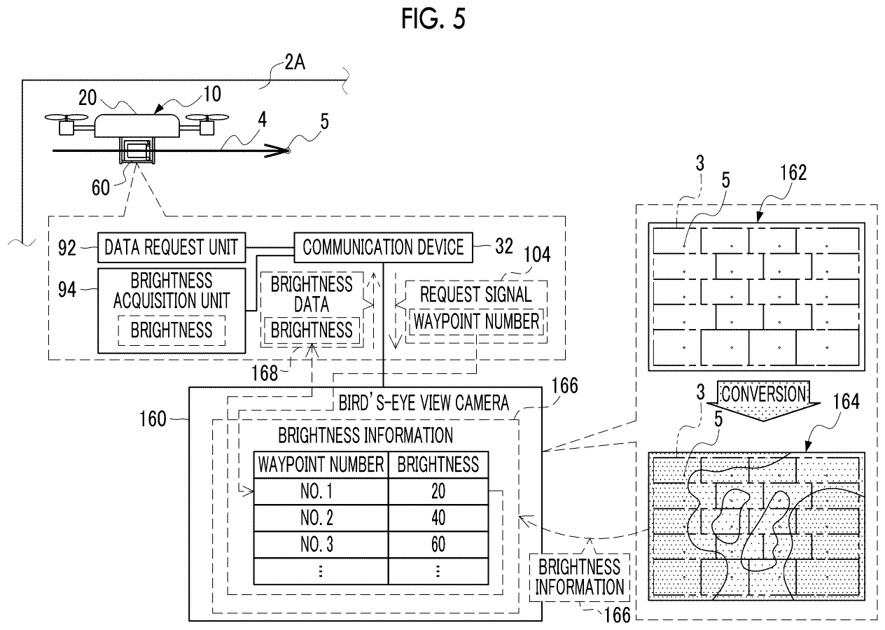

As shown in FIG. 5 as an example, the bird's-eye view camera 160 images the entire wall surface 2A including the plurality of imaging target regions 3 at the time before the flying object 20 reaches the target waypoint 5 (for example, a time before the flying object 20 starts flying along the flight route 4). With the imaging of the entire wall surface 2A by the bird's-eye view camera 160, an image 162 including the entire wall surface 2A as an image (hereinafter referred to as “wall surface image 162”) is obtained.

The bird's-eye view camera 160 derives the brightness for each imaging target region 3 corresponding to each waypoint 5, based on the wall surface image 162. For example, the wall surface image 162 is an RGB image formed by three primary colors of light, and the bird's-eye view camera 160 generates an image 164 based on the RGB image. The image 164 is an image in which a color space of the RGB image is converted into a color space different from the RGB. Hereinafter, the image 164 is referred to as “converted image 164”. The converted image 164 includes a component of brightness indicating a degree of brightness. Examples of the color space of the converted image 164 include a Lab color space, an Lch color space, and an HSV color space. The bird's-eye view camera 160 derives the brightness for each imaging target region 3 corresponding to each waypoint 5, based on the component of brightness included in the converted image 164.

The brightness of the imaging target region 3 may be derived with a standard light source (for example, D50 or D65) determined by CIE as a reference. Further, the brightness of the imaging target region 3 may be a representative value (for example, minimum value, maximum value, or center value) of the brightness of the entire imaging target region 3, or may be an average value of the brightness of the entire imaging target region 3. Further, the brightness of the imaging target region 3 may be the brightness of the entire imaging target region 3 or the brightness of a part of the imaging target region 3. The brightness of the part of the imaging target region 3 may be the brightness of a center portion of the imaging target region 3 or may be the brightness of a portion different from the center portion of the imaging target region 3.

The bird's-eye view camera 160 generates information related to the brightness for each imaging target region 3 corresponding to each waypoint 5 as brightness information 166, and stores the generated brightness information 166. For example, the brightness information 166 is information representing a relationship between a number indicating an order of each waypoint 5 (hereinafter referred to as “waypoint number”) and the brightness of the imaging target region 3. FIG. 5 shows an example of a specific value of the brightness of the imaging target region 3 corresponding to each waypoint number, as an example of the brightness information 166. The brightness is represented by, for example, a lightness indicating a degree of brightness.

The data request unit 92 transmits a request signal 104 for requesting brightness data 168 to the bird's-eye view camera 160 via the communication device 32. The brightness data 168 indicates the brightness of the imaging target region 3 corresponding to the target waypoint 5. The request signal 104 includes information indicating the waypoint number corresponding to the target waypoint 5.

In a case where the request signal 104 is received, the bird's-eye view camera 160 extracts the brightness corresponding to the waypoint number indicated by the request signal 104 from the brightness information 166 and transmits the brightness data 168 indicating the extracted brightness to the communication device 32. In the example shown in FIG. 5, the waypoint number indicated by the request signal 104 is “NO. 1”, and the bird's-eye view camera 160 transmits, to the communication device 32, the brightness data 168 indicating “20”, which is the degree of brightness corresponding to “NO. 1”.

The brightness acquisition unit 94 acquires the brightness of the imaging target region 3 corresponding to the target waypoint 5, based on the brightness data 168 received by the communication device 32. In the example shown in FIG. 5, the brightness acquired by the brightness acquisition unit 94 is detected at a time before the flying object 20 starts moving along the flight route 4.

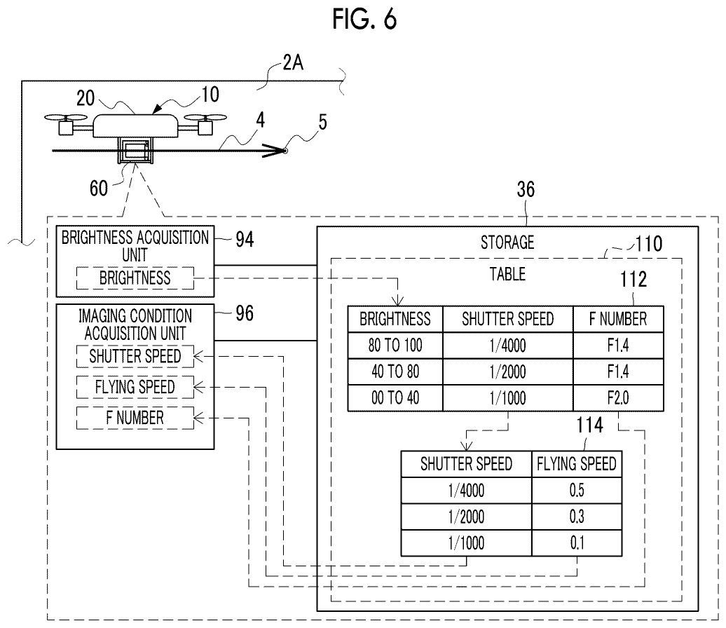

As shown in FIG. 6 as an example, the storage 36 stores a table 110. The table 110 is an example of “relationship information” according to the technology of the present disclosure, and the storage 36 is an example of “memory” according to the technology of the present disclosure. The table 110 has a first table 112 and a second table 114. The first table 112 shows a relationship between the brightness, the shutter speed, and the F number, and the second table 114 shows a relationship between the shutter speed and the flying speed.

In FIG. 6, the first table 112 shows an example of specific values of the brightness, the shutter speed, and the F number, and the second table 114 shows an example of specific values of the shutter speed and the flying speed. The unit of the shutter speed is “second(s)”, and the unit of the flying speed is “meter per second (m/s)”.

The shutter speed is set to, for example, a value at which image shake occurring during the exposure on the light-receiving surface 78A falls within an allowable range. The image shake is defined by, for example, a moving distance of the image on the light-receiving surface 78A (for example, moving distance corresponding to the number of pixels). The allowable range is set based on, for example, image quality (for example, image quality in which the feature point may be identified) required for the image for composition 132. The F number is set based on the brightness and/or the shutter speed. The flying speed is set to a value at which the image shake falls within the allowable range for each shutter speed.

In the example shown in FIG. 6, the table 110 has the first table 112 and the second table 114, but may be one table showing a relationship between the brightness, the shutter speed, the F number, and the flying speed. Further, in the example shown in FIG. 6, the storage 36 stores the first table 112 and the second table 114, but may store a first relational expression indicating the relationship between the brightness, the shutter speed, and the F number instead of the first table 112, and a second relational expression indicating the relationship between the shutter speed and the flying speed instead of the second table 114. Further, the first table 112 stores different F-numbers according to the brightness and the shutter speed, but the F-number may be constant.

The imaging condition acquisition unit 96 acquires an imaging condition based on the brightness acquired by the brightness acquisition unit 94. The imaging condition includes the shutter speed, the F number, and the flying speed. The imaging condition acquisition unit 96 acquires the shutter speed and the F number corresponding to the brightness, which is acquired by the brightness acquisition unit 94, based on a first table 112. Further, the imaging condition acquisition unit 96 acquires the flying speed corresponding to the shutter speed, which is acquired based on the first table 112, based on the second table 114.

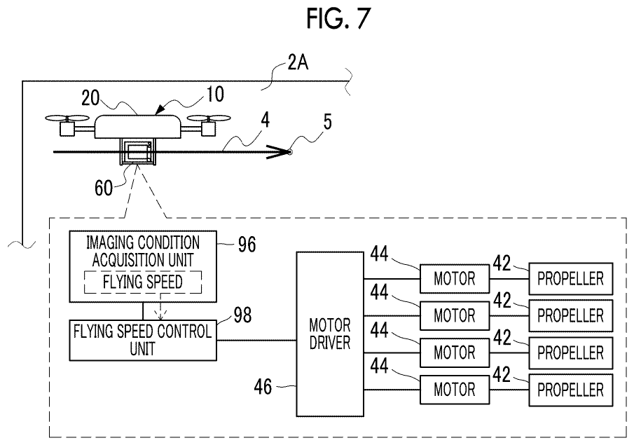

As shown in FIG. 7 as an example, with the control of the plurality of motors 44 via the motor driver 46 based on the flying speed acquired by the imaging condition acquisition unit 96, the flying speed control unit 98 sets the flying speed of the flying object 20 to the flying speed acquired by the imaging condition acquisition unit 96. Accordingly, a rotation speed of the plurality of propellers 42 is adjusted, and the flying speed of the flying object 20 is set to the flying speed acquired by the imaging condition acquisition unit 96.

As shown in FIG. 8 as an example, the storage 36 stores the flight route information 116 indicating the flight route 4. The flight route information 116 includes position information indicating positions of the plurality of waypoints 5 set on the flight route 4.

The reach determination unit 100 acquires the position of the flying object 20 based on the positioning data 48, which is input from the positioning unit 28, and/or the acceleration data 50, which is input from the acceleration sensor 30. The reach determination unit 100 determines whether or not the flying object 20 has reached the target waypoint 5, based on the acquired position of the flying object 20 and the position of the target waypoint 5 indicated by the flight route information 116.

In a case where the reach determination unit 100 determines that the flying object 20 has reached the target waypoint 5, the imaging control unit 102 causes the imaging apparatus 60 to image the imaging target region 3 corresponding to the target waypoint 5 with the shutter speed and the F number acquired by the imaging condition acquisition unit 96.

Specifically, with the control of the shutter actuator 70 via the controller 72, the imaging control unit 102 opens and closes the front curtain 68A and the rear curtain 68B for a time corresponding to the shutter speed acquired by the imaging condition acquisition unit 96. Further, with the control of the stop actuator 66 via the controller 72, the size of the opening 64A of the stop 64 is adjusted to a size corresponding to the F number acquired by the imaging condition acquisition unit 96. Further, with the control of the image sensor 74 via the image sensor driver 76, the imaging control unit 102 causes the image sensor 74 to output the imaging data 82. The imaging data 82 is image data indicating the image for composition 132 obtained by imaging the imaging target region 3, and is subjected to various types of processing by the processor 34 (refer to FIG. 2) and then stored in the storage 36.

The flying speed of the flying object 20 is maintained at the flying speed acquired by the imaging condition acquisition unit 96 until the imaging control unit 102 images the imaging target region 3. The flying speed of the flying object 20 may be changed to the flying speed higher than the flying speed, which is acquired by the imaging condition acquisition unit 96, after the imaging control unit 102 images the imaging target region 3, until the flying speed is controlled again by the flying speed control unit 98 in correspondence with a next target waypoint 5. With the change to the flying speed higher than the flying speed acquired by the imaging condition acquisition unit 96, it is possible to improve the efficiency of imaging work.

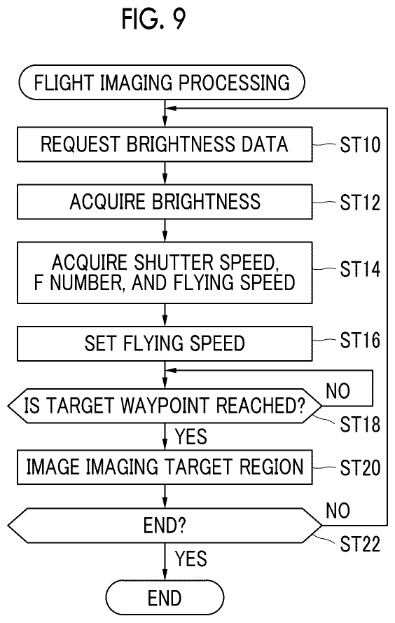

Next, an action of the flight imaging apparatus 10 according to the first embodiment will be described with reference to FIG. 9. FIG. 9 shows an example of a flow of the flight imaging processing according to the first embodiment.

In the flight imaging processing shown in FIG. 9, first, in step ST10, the data request unit 92 transmits the request signal 104 for requesting the brightness data 168 indicating the brightness of the imaging target region 3, which corresponds to the target waypoint 5, to the bird's-eye view camera 160 via the communication device 32 (refer to FIG. 5). After the processing of step ST10 is executed, the flight imaging processing transitions to step ST12.

In step ST12, the brightness acquisition unit 94 acquires the brightness of the imaging target region 3 corresponding to the target waypoint 5, based on the brightness data 168, which is transmitted from the bird's-eye view camera 160 and received by the communication device 32 (refer to FIG. 5). After the processing of step ST12 is executed, the flight imaging processing transitions to step ST14.

In step ST14, the imaging condition acquisition unit 96 acquires the shutter speed and the F number, which correspond to the brightness acquired in step ST12, based on the first table 112 stored in the storage 36 (refer to FIG. 6). Further, the imaging condition acquisition unit 96 acquires the flying speed corresponding to the shutter speed, which is acquired based on the first table 112, based on the second table 114 stored in the storage 36 (refer to FIG. 6). After the processing of step ST14 is executed, the flight imaging processing transitions to step ST16.

In step ST16, with the control of the plurality of motors 44 via the motor driver 46, the flying speed control unit 98 sets the flying speed of the flying object 20 to the flying speed acquired in step ST14 (refer to FIG. 7). Accordingly, the rotation speed of the plurality of propellers 42 is adjusted, and the flying speed of the flying object 20 is set to the flying speed acquired in step ST14. After the processing of step ST16 is executed, the flight imaging processing transitions to step ST18.

In step ST18, the reach determination unit 100 acquires the position of the flying object 20 based on the positioning data 48, which is input from the positioning unit 28, and/or the acceleration data 50, which is input from the acceleration sensor 30 (refer to FIG. 8). The reach determination unit 100 determines whether or not the flying object 20 has reached the target waypoint 5, based on the acquired position of the flying object 20 and the position of the waypoint 5 indicated by the flight route information 116 stored in the storage 36 (refer to FIG. 8). In step ST18, in a case where the flying object 20 has reached the target waypoint 5, the determination is positive, and the flight imaging processing transitions to step ST20. In step ST18, in a case where the flying object 20 has not reached the target waypoint 5, the determination is negative, and the flight imaging processing executes the processing of step ST18 again.

In step ST20, the imaging control unit 102 causes the imaging apparatus 60 to image the imaging target region 3 corresponding to the target waypoint 5 with the shutter speed and the F number, which are acquired in step ST14 (refer to FIG. 8). After the processing of step ST20 is executed, the flight imaging processing transitions to step ST22.

In step ST22, the processor 34 determines whether or not a condition for ending the flight imaging processing (end condition) is satisfied. An example of the end condition includes a condition that the imaging apparatus 60 images the imaging target region 3 corresponding to the final waypoint 5 or a condition that a user gives an instruction to end the flight imaging processing to the flight imaging apparatus 10. In step ST22, in a case where the end condition is not satisfied, the determination is negative, and the flight imaging processing transitions to step ST10. In step ST22, in a case where the end condition is satisfied, the determination is positive, and the flight imaging processing ends. The control method described as the action of the flight imaging apparatus 10 is an example of “control method” according to the technology of the present disclosure.

As described above, in the flight imaging apparatus 10 according to the first embodiment, the processor 34 acquires, from the target waypoint 5, the brightness of the imaging target region 3 imaged by the imaging apparatus 60 at the time before the flying object 20 reaches the target waypoint 5 (refer to FIG. 5). Further, the processor 34 acquires the shutter speed corresponding to the acquired brightness and the flying speed corresponding to the shutter speed (refer to FIG. 6). The processor 34 causes, at the target waypoint 5, the imaging apparatus 60 to image the imaging target region 3 at the acquired shutter speed (refer to FIG. 8) while causing the flying object 20 to fly at the acquired flying speed (refer to FIG. 7). Therefore, at the target waypoint 5, the imaging target region 3 can be imaged by the imaging apparatus 60 at the shutter speed corresponding to the brightness of the imaging target region 3 while the flying object 20 is caused to fly at the flying speed corresponding to the shutter speed.

Further, the processor 34 acquires the shutter speed corresponding to the brightness and the flying speed corresponding to the shutter speed based on the table 110 representing the relationship between the brightness, the shutter speed, and the flying speed (refer to FIG. 6). Therefore, it is possible to acquire the shutter speed and the flying speed, which are defined in advance by the table 110, based on the brightness.

Further, the computer 26 comprises the storage 36 that stores the table 110 (refer to FIG. 6). Therefore, for example, it is possible to acquire the shutter speed and the flying speed based on the table 110 stored in the storage 36 directly connected to the processor 34.

Further, the brightness is detected by using the bird's-eye view camera 160 (refer to FIG. 5). Therefore, for example, it is possible to detect the brightness of the plurality of imaging target regions 3 from the position farther from the wall surface 2A than the flight imaging apparatus 10.

Further, the bird's-eye view camera 160 images the entire wall surface 2A including the plurality of imaging target regions 3 (refer to FIG. 5). Therefore, for example, since the number of imaging operations can be reduced as compared with a case where the brightness of each imaging target region 3 is individually detected based on the image obtained by imaging each of the plurality of imaging target regions 3 one by one, it is possible to improve the workability in a case where the brightness of the plurality of imaging target regions 3 is detected.

Further, the brightness is detected at the time before the flying object 20 starts flying along the flight route 4 (refer to FIG. 5). Accordingly, the shutter speed corresponding to the brightness and the flying speed corresponding to the shutter speed are acquired based on the brightness detected at the time before the flying object 20 starts flying along the flight route 4. Accordingly, for example, it is possible to cause the flight imaging apparatus 10 to perform the imaging in a state where appropriate shutter speed and flying speed (for example, shutter speed and flying speed at which the image shake does not occur) are set at the target waypoint 5, as compared with a case where the brightness is detected at a timing at which the flight imaging apparatus 10 has reached the target waypoint 5.

Further, the plurality of waypoints 5 are set on the flight route 4, and the processor 34 causes the imaging apparatus 60 to image the imaging target region 3 with the F number (refer to FIG. 6) corresponding to the brightness and/or the shutter speed for each waypoint 5. Therefore, even in a case where conditions related to the brightness and/or the shutter speed are different for each waypoint 5, it is possible to image the imaging target region 3 with the F number corresponding to the brightness and/or the shutter speed.

Further, the image for composition 132 is obtained by imaging the imaging target region 3 with the imaging apparatus 60 for each waypoint 5 (refer to FIG. 8). The image for composition 132 is obtained by the partial overlap of the images for composition 132 adjacent to each other. Therefore, it is possible to composite the images for composition 132 corresponding to the imaging target regions 3 adjacent to each other based on the feature point included in the overlapping portion of the imaging target regions 3 adjacent to each other.

In the first embodiment, the processor 34 may cause, at the plurality of waypoints 5, the imaging apparatus 60 to image the imaging target region 3 with a constant F number. In this case, it is possible to omit the processing of causing the stop 64 to operate for each waypoint 5.

### Second Embodiment

Next, a second embodiment will be described.

In the first embodiment, the bird's-eye view camera 160 images the entire wall surface 2A including the plurality of imaging target regions 3 at the time before the flying object 20 starts flying along the flight route 4. In the second embodiment, the timing at which the bird's-eye view camera 160 images the wall surface 2A is different from that in the first embodiment. Hereinafter, a specific description will be made.

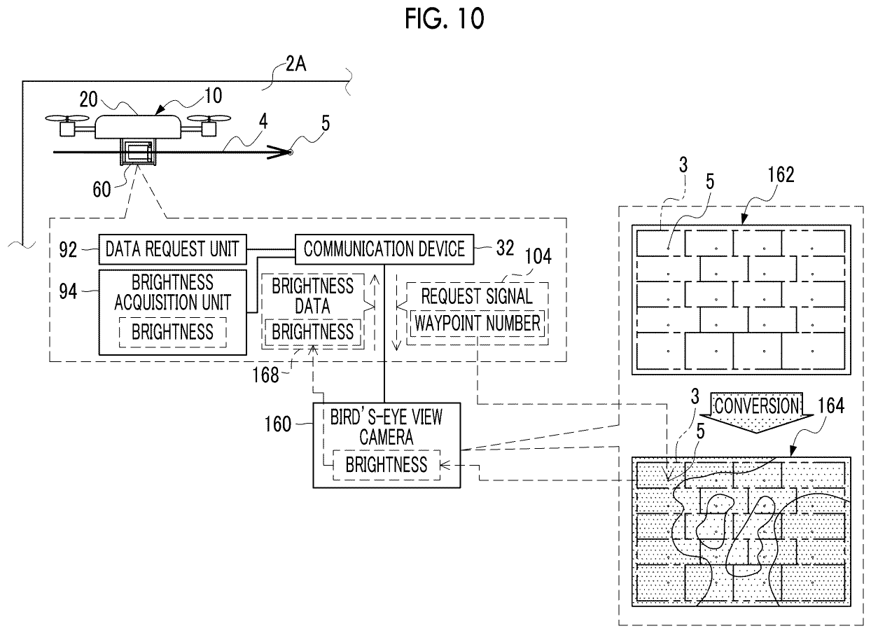

As shown in FIG. 10 as an example, the data request unit 92 transmits the request signal 104 for requesting the brightness data 168 to the bird's-eye view camera 160 via the communication device 32 at the time before the flying object 20 reaches the target waypoint 5 after the flying object 20 starts moving along the flight route 4. The brightness data 168 indicates the brightness of the imaging target region 3 corresponding to the target waypoint 5. The request signal 104 includes information indicating the waypoint number corresponding to the target waypoint 5.

In a case where the request signal 104 is received, the bird's-eye view camera 160 images the entire wall surface 2A including the plurality of imaging target regions 3. Accordingly, the wall surface image 162 is obtained. Further, the bird's-eye view camera 160 converts the wall surface image 162 into the converted image 164, and derives the brightness of the imaging target region 3 corresponding to the target waypoint 5 based on the component of brightness included in the converted image 164. A method of deriving the brightness of the imaging target region 3 is the same as that of the first embodiment. The bird's-eye view camera 160 transmits the brightness data 168 indicating the derived brightness to the communication device 32.

The bird's-eye view camera 160 may extract, from the wall surface image 162 obtained by imaging the entire wall surface 2A, an image including only the imaging target region 3, which corresponds to the waypoint number indicated by the request signal 104, as an image. The bird's-eye view camera 160 may convert the extracted image into the converted image 164, and derive the brightness of only the imaging target region 3 corresponding to the target waypoint 5 based on the component of brightness included in the converted image 164 obtained by the conversion.

Further, the bird's-eye view camera 160 may image only the imaging target region 3 corresponding to the waypoint number indicated by the request signal 104. The bird's-eye view camera 160 may convert the image obtained by the imaging into the converted image 164, and derive the brightness of only the imaging target region 3 corresponding to the target waypoint 5 based on the component of brightness included in the converted image 164 obtained by the conversion.

The brightness acquisition unit 94 acquires the brightness of the imaging target region 3 corresponding to the target waypoint 5, based on the brightness data 168 received by the communication device 32.

As described in detail above, in the second embodiment, the brightness acquired by the brightness acquisition unit 94 is detected at the time before the flying object 20 reaches the target waypoint 5 after the flying object 20 starts moving along the flight route 4. Accordingly, the shutter speed corresponding to the brightness and the flying speed corresponding to the shutter speed are acquired based on the brightness detected at the time before the flying object 20 reaches the target waypoint 5 after the flying object 20 starts moving along the flight route 4. Accordingly, for example, it is possible to cause the flight imaging apparatus 10 to perform the imaging in a state where appropriate shutter speed and flying speed (for example, shutter speed and flying speed at which the image shake does not occur) are set at the target waypoint 5, as compared with a case where the brightness is detected at a timing at which the flight imaging apparatus 10 has reached the target waypoint 5.

Further, even in a case where the flying object 20 starts moving along the flight route 4 and then the brightness is changed, it is possible to detect the changed brightness at the time before the flying object 20 reaches the target waypoint 5. Accordingly, for example, it is possible to improve detection accuracy of the brightness as compared with a case where the brightness is detected before the flying object 20 starts moving along the flight route 4.

### Third Embodiment

Next, a third embodiment will be described.

In the first embodiment, the brightness for each imaging target region 3 corresponding to each waypoint 5 is detected based on the wall surface image 162 obtained by being captured by the bird's-eye view camera 160. In the third embodiment, a method of detecting the brightness for each imaging target region 3 corresponding to each waypoint 5 is different from that of the first embodiment. Hereinafter, a specific description will be made.

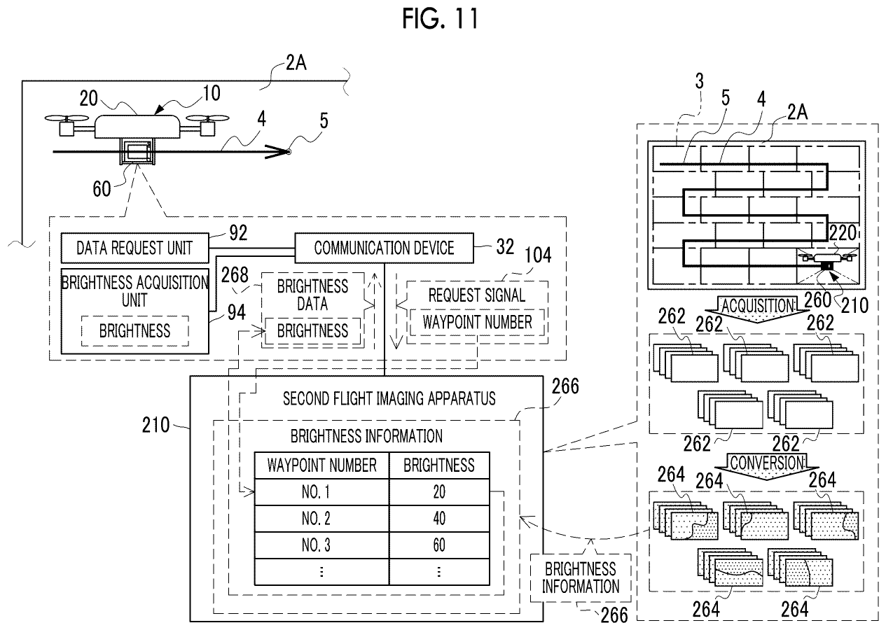

As shown in FIG. 11 as an example, in the third embodiment, a flight imaging apparatus 210 different from the flight imaging apparatus 10 is used instead of the bird's-eye view camera 160. Hereinafter, in a case where there is a need to distinguish between the flight imaging apparatus 10 and the flight imaging apparatus 210, the flight imaging apparatus 10 is referred to as “first flight imaging apparatus 10”, and the flight imaging apparatus 210 is referred to as “second flight imaging apparatus 210”.

The second flight imaging apparatus 210 has the same hardware configuration as the first flight imaging apparatus 10. Specifically, the second flight imaging apparatus 210 comprises a flying object 220 and an imaging apparatus 260. The flying object 220 has the same configuration as the flying object 20 provided in the first flight imaging apparatus 10, and the imaging apparatus 260 has the same configuration as the imaging apparatus 60 provided in the first flight imaging apparatus 10. The flying object 220 provided in the second flight imaging apparatus 210 is an example of “second moving object” according to the technology of the present disclosure. The imaging apparatus 260 provided in the second flight imaging apparatus 210 is an example of “sensor” according to the technology of the present disclosure.

The second flight imaging apparatus 210 images the imaging target region 3 corresponding to each waypoint 5, each time the first flight imaging apparatus 10 reaches the waypoint 5 while flying along the flight route 4, at a time before the first flight imaging apparatus 10 reaches the target waypoint 5 (for example, time before the first flight imaging apparatus 10 starts flying along the flight route 4). With the imaging of each imaging target region 3, an image 262 (hereinafter referred to as “imaging target region image 262”) including the imaging target region 3 as an image is obtained.

As an example, the second flight imaging apparatus 210 flies along the flight route 4 at a flying speed higher than the flying speed in a case where the first flight imaging apparatus 10 flies along the flight route 4. The flying speed may be calculated, for example, as an average value of the flying speeds during a period from a start of the flight for the flight route 4 to an end of the flight. With the setting of the flying speed of the second flight imaging apparatus 210 to be higher than the flying speed of the first flight imaging apparatus 10, it is possible to improve the efficiency of the imaging work by the second flight imaging apparatus 210.

The second flight imaging apparatus 210 derives the brightness for each imaging target region 3 corresponding to each waypoint 5, based on the imaging target region image 262 obtained each time the second flight imaging apparatus 210 reaches the waypoint 5. For example, the imaging target region image 262 is an RGB image formed by three primary colors of light, and the second flight imaging apparatus 210 converts the RGB image into an image 264. Hereinafter, the image 264 is referred to as “converted image 264”. The converted image 264 is the same as the converted image 164 (refer to FIG. 5) of the first embodiment. The second flight imaging apparatus 210 derives the brightness for each imaging target region 3 corresponding to each waypoint 5, based on the component of brightness included in the converted image 264. A method of deriving the brightness for each imaging target region 3 is the same as that of the first embodiment.

Further, the second flight imaging apparatus 210 generates, as brightness information 266, information related to the brightness for each imaging target region 3 corresponding to each waypoint 5, and stores the generated brightness information 266. The brightness information 266 is the same as the brightness information 166 (refer to FIG. 5) of the first embodiment. FIG. 11 shows an example of a specific value of the brightness of the imaging target region 3 corresponding to each waypoint number, as an example of the brightness information 266.

The data request unit 92 transmits the request signal 104 for requesting brightness data 268 to the second flight imaging apparatus 210 via the communication device 32. The brightness data 268 indicates the brightness of the imaging target region 3 corresponding to the target waypoint 5. The request signal 104 includes information indicating the waypoint number corresponding to the target waypoint 5.

In a case where the request signal 104 is received, the second flight imaging apparatus 210 extracts, from the brightness information 266, the brightness corresponding to the waypoint number indicated by the request signal 104 and transmits the brightness data 268 indicating the extracted brightness to the communication device 32 of the first flight imaging apparatus 10. In the example shown in FIG. 11, the waypoint number indicated by the request signal 104 is “NO. 1”, and brightness data 268 indicating “20”, which is the degree of brightness corresponding to “NO. 1”, is transmitted to the communication device 32 by the second flight imaging apparatus 210.

The brightness acquisition unit 94 acquires the brightness of the imaging target region 3 corresponding to the target waypoint 5, based on the brightness data 268 received by the communication device 32.

As described in detail above, in the third embodiment, the brightness acquired by the brightness acquisition unit 94 is detected at a time before the first flight imaging apparatus 10 starts moving along the flight route 4. Accordingly, the shutter speed corresponding to the brightness and the flying speed corresponding to the shutter speed are acquired based on the brightness detected at the time before the flying object 20 starts flying along the flight route 4. Accordingly, for example, it is possible to cause the flight imaging apparatus 10 to perform the imaging in a state where appropriate shutter speed and flying speed (for example, shutter speed and flying speed at which the image shake does not occur) are set at the target waypoint 5, as compared with a case where the brightness is detected at a timing at which the flight imaging apparatus 10 has reached the target waypoint 5.

Further, the brightness acquired by the brightness acquisition unit 94 is detected from the target waypoint 5 by using the imaging apparatus 60 of the second flight imaging apparatus 210. Therefore, for example, it is possible to improve the detection accuracy of the brightness as compared with the brightness detected by using the imaging apparatus 60 from a position farther from the wall surface 2A than the target waypoint 5.

Further, the imaging apparatus 60 is mounted on the second flight imaging apparatus 210. Therefore, it is possible to detect the brightness of the imaging target region 3 at each waypoint 5 while the second flight imaging apparatus 210 is caused to fly.

Further, the second flight imaging apparatus 210 flies along the flight route 4 at the flying speed higher than the first flight imaging apparatus 10. Accordingly, it is possible to shorten a time required for the second flight imaging apparatus 210 to fly along the flight route 4 as compared with a time required for the first flight imaging apparatus 10 to fly along the flight route 4.

In the third embodiment, the imaging apparatus 260 is used to detect the brightness of the imaging target region 3. However, an illuminance sensor (not shown) may be used instead of the imaging apparatus 260. The illuminance sensor is an example of “sensor” according to the technology of the present disclosure.

Further, in the third embodiment, the second flight imaging apparatus 210 different from the first flight imaging apparatus 10 is used. However, the first flight imaging apparatus 10 may be used instead of the second flight imaging apparatus 210. In this case, the flying object 20 provided in the first flight imaging apparatus 10 is an example of “first moving object” and “second moving object” according to the technology of the present disclosure.

### Fourth Embodiment

Next, a fourth embodiment will be described.

In the third embodiment, the second flight imaging apparatus 210 images the imaging target region 3 corresponding to each waypoint 5 each time the second flight imaging apparatus 210 reaches the waypoint 5 while flying along the flight route 4 at the time before the first flight imaging apparatus 10 starts flying along the flight route 4. In the fourth embodiment, a timing at which the second flight imaging apparatus 210 images the imaging target region 3 corresponding to each waypoint 5 is different from that in the third embodiment. Hereinafter, a specific description will be made.

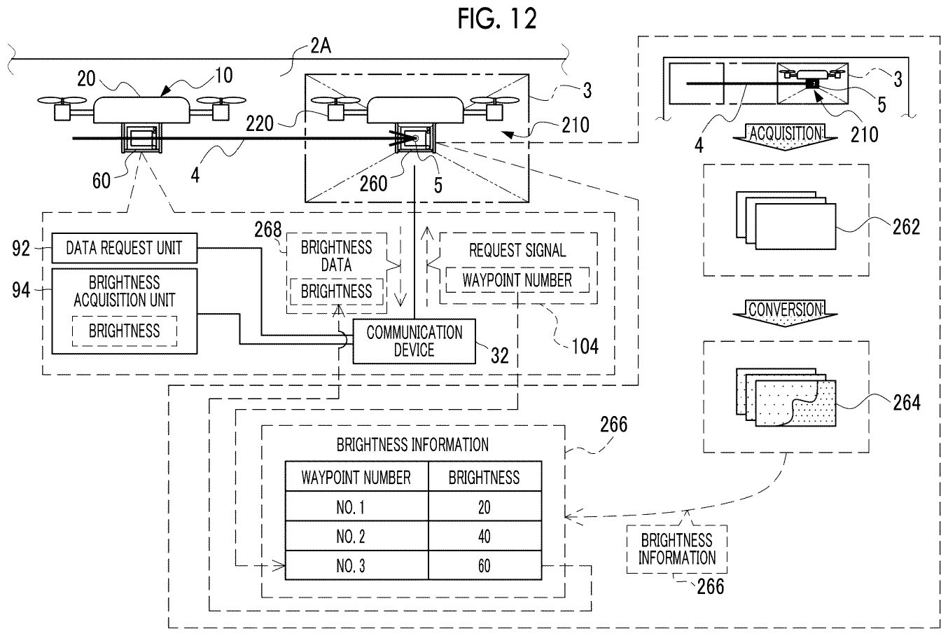

As shown in FIG. 12 as an example, the second flight imaging apparatus 210 flies earlier than the first flight imaging apparatus 10. A distance between centers of the first flight imaging apparatus 10 and the second flight imaging apparatus 210 along the flight route 4 may be set to a distance shorter than a distance between centers of the waypoints 5 adjacent to each other, or may be set to a distance longer than a distance between the waypoints 5 adjacent to each other.

The second flight imaging apparatus 210 images the imaging target region 3 corresponding to each waypoint 5 each time the second flight imaging apparatus 210 reaches the waypoint 5 while flying along the flight route 4 earlier than the first flight imaging apparatus 10. With the imaging of each imaging target region 3, the imaging target region image 262 is obtained.

The second flight imaging apparatus 210 converts the imaging target region image 262 obtained each time the second flight imaging apparatus 210 reaches the waypoint 5 into the converted image 264, and derives the brightness for each imaging target region 3 corresponding to each waypoint 5 based on the component of brightness included in the converted image 264. A method of deriving the brightness for each imaging target region 3 is the same as that of the third embodiment.

Further, the second flight imaging apparatus 210 generates, as brightness information 266, information related to the brightness for each imaging target region 3 corresponding to each waypoint 5, and stores the generated brightness information 266. The brightness information 266 is the same as in the third embodiment. FIG. 12 shows an example of a specific value of the brightness of the imaging target region 3 corresponding to each waypoint number, as an example of the brightness information 266.

The data request unit 92 transmits the request signal 104 for requesting the brightness data 268 to the second flight imaging apparatus 210 via the communication device 32 at the time before the first flight imaging apparatus 10 reaches the target waypoint 5 after the first flight imaging apparatus 10 starts moving along the flight route 4. The brightness data 268 indicates the brightness of the imaging target region 3 corresponding to the target waypoint 5. The request signal 104 includes information indicating the waypoint number corresponding to the target waypoint 5.

In a case where the request signal 104 is received, the second flight imaging apparatus 210 extracts, from the brightness information 266, the brightness corresponding to the waypoint number indicated by the request signal 104 and transmits the brightness data 268 indicating the extracted brightness to the communication device 32 of the first flight imaging apparatus 10. In the example shown in FIG. 12, the waypoint number indicated by the request signal 104 is “NO. 3”, and the brightness data 268 indicating “60”, which is the degree of brightness corresponding to “NO. 3”, is transmitted to the communication device 32 by the second flight imaging apparatus 210.

The brightness acquisition unit 94 acquires the brightness of the imaging target region 3 corresponding to the target waypoint 5, based on the brightness data 268 received by the communication device 32.

As described in detail above, in the fourth embodiment, the brightness acquired by the brightness acquisition unit 94 is detected at the time before the first flight imaging apparatus 10 reaches the target waypoint 5 after the first flight imaging apparatus 10 starts moving along the flight route 4. Accordingly, the shutter speed corresponding to the brightness and the flying speed corresponding to the shutter speed are acquired based on the brightness detected at the time before the flying object 20 reaches the target waypoint 5 after the flying object 20 starts moving along the flight route 4. Accordingly, for example, it is possible to cause the flight imaging apparatus 10 to perform the imaging in a state where appropriate shutter speed and flying speed (for example, shutter speed and flying speed at which the image shake does not occur) are set at the target waypoint 5, as compared with a case where the brightness is detected at a timing at which the flight imaging apparatus 10 has reached the target waypoint 5.

Further, even in a case where the flying object 20 starts moving along the flight route 4 and then the brightness is changed, it is possible to detect the changed brightness at the time before the flying object 20 reaches the target waypoint 5. Accordingly, for example, it is possible to improve detection accuracy of the brightness as compared with a case where the brightness is detected before the flying object 20 starts moving along the flight route 4.

### Fifth Embodiment

Next, a fifth embodiment will be described.

In the fifth embodiment, the processor 34 provided in the flight imaging apparatus 10 acquires the plurality of images for composition 132, and composites the images for composition 132 adjacent to each other to generate the composite image 130. Further, the processor 34 performs correction processing on the composite image 130. The correction processing is an example of “specific processing” and “correction processing” according to the technology of the present disclosure, and will be specifically described below.

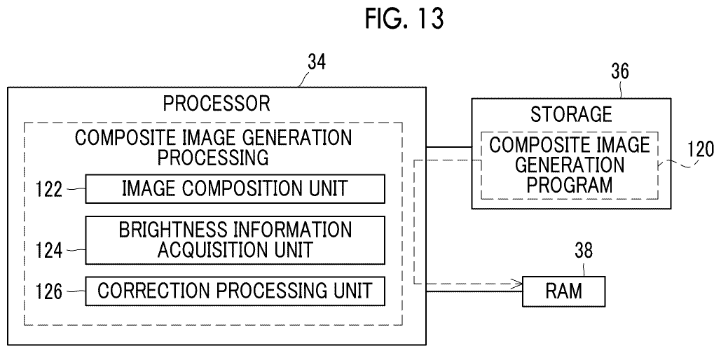

As shown in FIG. 13 as an example, the storage 36 stores a composite image generation program 120. The processor 34 reads out the composite image generation program 120 from the storage 36, and executes the readout composite image generation program 120 on the RAM 38. The processor 34 performs composite image generation processing in accordance with the composite image generation program 120 executed on the RAM 38. The composite image generation processing is realized by the processor 34 operating as an image composition unit 122, a brightness information acquisition unit 124, and a correction processing unit 126 in accordance with the composite image generation program 120. The processor 34 is an example of “second processor” according to the technology of the present disclosure.

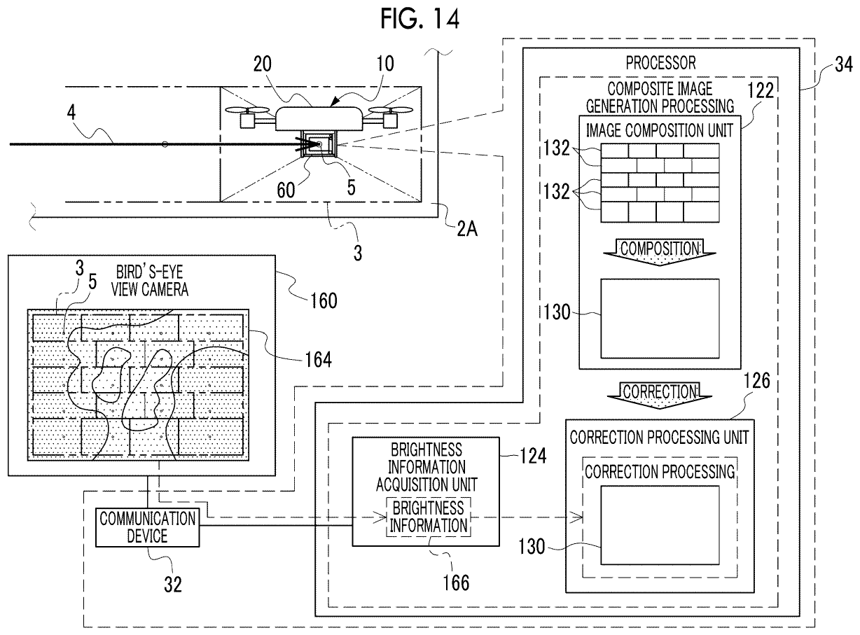

As shown in FIG. 14 as an example, the image composition unit 122 composites the images for composition 132 adjacent to each other with the plurality of images for composition 132 obtained by the imaging of each imaging target region 3 to generate the composite image 130.

The brightness information acquisition unit 124 acquires the brightness information 166 generated by the bird's-eye view camera 160. As described in the first embodiment, the brightness information 166 is the information generated based on the component of the brightness included in the converted image 164, and is the information indicating the brightness for each imaging target region 3 corresponding to each waypoint 5.

The correction processing unit 126 executes the correction processing on the composite image 130 composited by the image composition unit 122. Specifically, the correction processing is to correct brightness of the composite image 130 based on the brightness information 166 acquired by the brightness information acquisition unit 124. In the correction processing, the brightness is corrected for a region excluding a region indicating the feature point in the composite image 130.

For example, processing of reducing the brightness of a region having the highest brightness in the composite image 130 (for example, region in which whiteout occurs) is executed as the correction processing. Further, for example, processing of correcting a difference in the brightness between the images for composition 132 adjacent to each other is executed as the correction processing. Further, for example, processing of correcting a difference in the brightness between the images for composition 132 at distant positions is executed as the correction processing. Examples of the images for composition 132 at the distant positions include the images for composition 132 in a positional relationship in which one image for composition 132 is disposed between the images for composition 132 at distant positions, and the images for composition 132 in a positional relationship in which the images for composition 132 are disposed at two corners of four corners of the composite image 130.

An example of the processing of correcting the difference in the brightness between the images for composition 132 includes processing of making the pieces of brightness of the images for composition 132 close to each other. Further, for example, processing of correcting a brightness distribution of the composite image 130, based on a distribution of the brightness of the plurality of imaging target regions 3, is executed as the correction processing. An example of the processing of correcting the brightness distribution of the composite image 130 includes processing of correcting unevenness in the brightness. The correction processing described above is executed on the composite image 130. The correction processing is an example of “specific processing” and “correction processing” according to the technology of the present disclosure.

The composite image generation processing may be executed, for example, after all the images for composition 132 are obtained for the wall surface 2A, or each time the image for composition 132 is obtained from the second frame and subsequent frames.

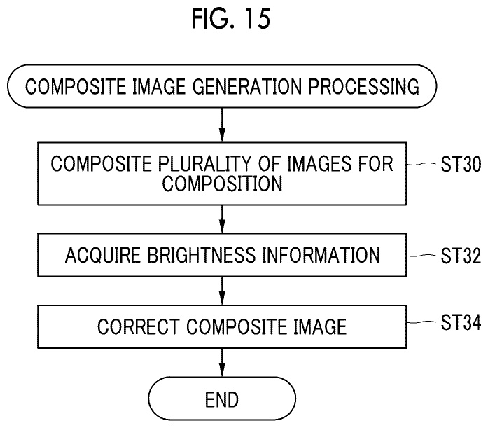

Next, an action of the flight imaging apparatus 10 according to the fifth embodiment will be described with reference to FIG. 15. FIG. 15 shows an example of a flow of the composite image generation processing according to the fifth embodiment.

In the composite image generation processing shown in FIG. 15, first, in step ST30, the image composition unit 122 generates the composite image 130 by compositing the images for composition 132 adjacent to each other to the plurality of images for composition 132 obtained by the imaging of each imaging target region 3. After the processing of step ST30 is executed, the composite image generation processing transitions to step ST32.

In step ST32, the brightness information acquisition unit 124 acquires the brightness information 166 generated by the bird's-eye view camera 160. After the processing of step ST32 is executed, the composite image generation processing transitions to step ST34.

In step ST34, with the execution of the correction process based on the brightness information 166 acquired in step ST32, the correction processing unit 126 corrects the brightness of the composite image 130 generated in step ST30. Accordingly, the composite image 130 whose brightness is corrected is obtained. After the processing of step ST34 is executed, the composite image generation processing ends.

As described in detail above, in the fifth embodiment, with the composition of the images for composition 132 adjacent to each other, the composite image 130 is generated. The correction processing is performed on the composite image 130, based on the brightness information 166 indicating the brightness of each imaging target region 3, to correct the brightness of the composite image 130. Therefore, for example, it is possible to suppress deterioration in the appearance of the composite image 130 due to unevenness in brightness or the like caused by the composition of the images for composition 132 adjacent to each other.

Further, the correction processing includes the processing of correcting the difference in the brightness between the images for composition 132. Therefore, it is possible to obtain the composite image 130 in which the difference in the brightness between the images for composition 132 is corrected, based on the brightness of each imaging target region 3.

Further, the correction processing includes the processing of correcting the brightness distribution of the composite image 130 based on the distribution of the brightness of the plurality of imaging target regions 3. Therefore, it is possible to obtain the composite image 130 in which the brightness distribution is corrected, based on the distribution of the brightness of the plurality of imaging target regions 3.

In the above description, the composite image generation processing is executed in the flight imaging apparatus 10, but may be executed in an external apparatus (not shown) that is communicably connected to the flight imaging apparatus 10.

Further, the specific processing may include notification processing of performing notification in a case where the difference in the brightness between the imaging target regions 3 exceeds a default value. The default value is set to, for example, an upper limit value of the difference in the brightness that does not affect the inspection or survey of the wall surface 2A based on the composite image 130. For example, processing of issuing a warning sound may be executed as the notification processing. The notification processing is an example of “specific processing” and “notification processing” according to the technology of the present disclosure. As described above, in a case where the notification processing of performing notification in a case where the difference in the brightness between the imaging target regions 3 exceeds the default value is performed, it is possible to cause the user or the like to recognize that the difference in the brightness between the imaging target regions 3 exceeds the default value.

Further, in the above embodiment, the flight imaging apparatus 10 is illustrated as an example of the moving object, but any moving object may be employed as long as the moving object moves on the movement route. Examples of the moving object include a car, a motorcycle, a bicycle, a cart, a gondola, an airplane, a flying object, and a ship.

Further, in the above embodiment, the plurality of waypoints 5 refer to all the waypoints 5 set on the flight route 4, but may refer to some waypoints 5 among all the waypoints 5 set on the flight route 4. Further, the number of waypoints 5 may be any number.

Further, in the above embodiment, the waypoint 5 set on the flight route 4 is used as an example of the target position, but a target position that is a position of a concept different from the waypoint 5 may be used.

Further, in the above embodiment, the imaging apparatus 60 images the imaging target region 3 to obtain the image for composition 132, but may image the imaging target region 3 for a purpose other than obtaining the image for composition 132.

Further, in the above embodiment, the processor 34 is illustrated, but at least one CPU, at least one GPU, and/or at least one TPU may be used instead of the processor 34 or together with the processor 34.

Further, in the above embodiment, the form example has been described in which the storage 36 stores the flight imaging program 90 and the composite image generation program 120, but the technology of the present disclosure is not limited thereto. For example, the flight imaging program 90 and/or the composite image generation program 120 may be stored in a portable non-transitory computer-readable storage medium (hereinafter simply referred to as “non-transitory storage medium”) such as an SSD or a USB memory. The flight imaging program 90 and/or the composite image generation program 120 stored in the non-transitory storage medium may be installed in the computer 26 of the flight imaging apparatus 10.

Further, the flight imaging program 90 and/or the composite image generation program 120 may be stored in a storage device of another computer, a server device, or the like connected to the flight imaging apparatus 10 via a network, and the flight imaging program 90 and/or the composite image generation program 120 may be downloaded in response to a request of the flight imaging apparatus 10 to be installed in the computer 26.

Further, there is no need to store all of the flight imaging program 90 and/or the composite image generation program 120 in the storage device of another computer, a server device, or the like connected to the flight imaging apparatus 10 or the storage 36, and a part of the flight imaging program 90 and/or the composite image generation program 120 may be stored.

While the computer 26 is built in the flight imaging apparatus 10, the technology of the present disclosure is not limited thereto. For example, the computer 26 may be provided outside the flight imaging apparatus 10.

Further, in the above embodiment, although the computer 26 including the processor 34, the storage 36, and the RAM 38 is illustrated, the technology of the present disclosure is not limited thereto, and a device including an ASIC, an FPGA, and/or a PLD may be applied instead of the computer 26. Further, a hardware configuration and a software configuration may be used in combination, instead of the computer 26.

Further, the following various processors can be used as a hardware resource for executing the various types of processing described in the above embodiment. Examples of the processor include a CPU that is a general-purpose processor functioning as the hardware resource for executing the various types of processing by executing software, that is, a program. Examples of the processor also include a dedicated electronic circuit such as an FPGA, a PLD, or an ASIC that is a processor having a circuit configuration dedicatedly designed to execute specific processing. Any processor includes a memory built therein or connected thereto, and any processor uses the memory to execute various types of processing.

The hardware resource for executing various types of processing may be configured by one of the various processors or may be configured by a combination of two or more processors that are the same type or different types (for example, combination of a plurality of FPGAs or combination of a CPU and an FPGA). Further, the hardware resource for executing the various types of processing may be one processor.

As a configuration example of one processor, first, there is a form in which one processor is configured by a combination of one or more CPUs and software and the processor functions as the hardware resource for executing the various types of processing. Second, as represented by an SoC or the like, a form of using a processor that implements functions of the entire system including a plurality of hardware resources for executing the various types of processing in one IC chip is included. As described above, the various types of processing are implemented by using one or more of the various processors as the hardware resource.

Furthermore, as the hardware structure of these various processors, more specifically, it is possible to use an electronic circuit in which circuit elements, such as semiconductor elements, are composited. The various types of processing is merely an example. Accordingly, it goes without saying that unnecessary steps may be deleted, new steps may be added, or the processing order may be changed within a range that does not deviate from the gist.

The contents described and the contents shown hereinabove are specific descriptions regarding the part according to the technique of the present disclosure and are merely examples of the technique of the present disclosure. For example, the descriptions regarding the configurations, the functions, the actions, and the effects are descriptions regarding an example of the configurations, the functions, the actions, and the effects of the part according to the technology of the present disclosure. Accordingly, in the contents described and the contents shown hereinabove, it is needless to say that removal of an unnecessary part, or addition or replacement of a new element may be employed within a range not departing from the gist of the present technology of the present disclosure. In order to avoid complication and easily understand the part according to the technique of the present disclosure, in the contents described and the contents shown hereinabove, the description regarding common general technical knowledge or the like which is not necessarily particularly described for enabling implementation of the technique of the present disclosure is omitted.

In the present specification, “A and/or B” is identical to “at least one of A or B”. That is, “A and/or B” may be only A, only B, or a combination of A and B. In the present specification, the same description regarding “A and/or B” is applied also in a case of expressing three or more items with the expression of “and/or”.

In a case where all of documents, patent applications, and technical standard described in the specification are incorporated in the specification as references, to the same degree as a case where the incorporation of each of documents, patent applications, and technical standard as references is specifically and individually noted.

What is claimed is:

1. A control device comprising:
a first processor,
wherein the first processor is configured to:
acquire, at a time before a first moving object equipped with an imaging apparatus reaches a target position, brightness of an imaging target region imaged by the imaging apparatus from the target position;
acquire a shutter speed corresponding to the brightness and a movement speed corresponding to the shutter speed; and
cause, at the target position, the imaging apparatus to image the imaging target region with the shutter speed while causing the first moving object to move with the movement speed.

2. The control device according to claim 1,
wherein the first processor is configured to acquire the shutter speed corresponding to the brightness and the movement speed corresponding to the shutter speed, based on relationship information representing a relationship between the brightness, the shutter speed, and the movement speed.

3. The control device according to claim 2, further comprising:
a memory that stores the relationship information.

4. The control device according to claim 1,
wherein the brightness is detected from the target position by using a sensor.

5. The control device according to claim 4,
wherein the sensor is mounted on a second moving object.

6. The control device according to claim 5,
wherein the target position is set on a movement route, and
the brightness is detected while the second moving object moves on the movement route with a speed higher than the movement speed.

7. The control device according to claim 1,
wherein the brightness is detected by using a bird's-eye view camera that views a subject including the imaging target region from above.

8. The control device according to claim 7,
wherein the subject includes a plurality of the imaging target regions.

9. The control device according to claim 1,
wherein the target position is set on a movement route, and
the brightness is detected at a time before the first moving object starts moving along the movement route.

10. The control device according to claim 1,
wherein the target position is set on a movement route, and
the brightness is detected at a time before the first moving object reaches the target position after the first moving object starts moving along the movement route.

11. The control device according to claim 1,
wherein a plurality of the target positions are set as movement destinations to which the first moving object moves, and
the first processor is configured to cause, at the plurality of target positions, the imaging apparatus to image the imaging target region with a constant F number.

12. The control device according to claim 1,
wherein a plurality of the target positions are set as movement destinations to which the first moving object moves, and
the first processor is configured to cause, for each target position, the imaging apparatus to image the imaging target region with an F number corresponding to the brightness and/or the shutter speed.

13. The control device according to claim 1,
wherein a plurality of the target positions are set as movement destinations to which the first moving object moves,
the first processor is configured to acquire, for each target position, an image for composition obtained by causing the imaging apparatus to image the imaging target region, and
the image for composition is an image in which the images for composition adjacent to each other partially overlap each other.

14. The control device according to claim 13, further comprising:
a second processor that composites the images for composition adjacent to each other to generate a composite image,
wherein the second processor is configured to perform specific processing on the composite image based on the brightness.

15. The control device according to claim 14,
wherein the specific processing includes correction processing of correcting brightness of the composite image.

16. The control device according to claim 15,
wherein the correction processing includes processing of correcting a difference in the brightness between the images for composition.

17. The control device according to claim 15,
wherein the correction processing includes processing of correcting a brightness distribution of the composite image based on a distribution of the brightness.

18. The control device according to claim 14,
wherein the specific processing includes notification processing of performing notification in a case where a difference in the brightness between the imaging target regions exceeds a default value.

19. A control method comprising:
acquiring, at a time before a first moving object equipped with an imaging apparatus reaches a target position, brightness of an imaging target region imaged by the imaging apparatus from the target position;
acquiring a shutter speed corresponding to the brightness and a movement speed corresponding to the shutter speed; and
causing, at the target position, the imaging apparatus to image the imaging target region with the shutter speed while causing the first moving object to move with the movement speed.

20. A non-transitory computer-readable storage medium storing a program causing a computer to execute a process comprising:
acquiring, at a time before a first moving object equipped with an imaging apparatus reaches a target position, brightness of an imaging target region imaged by the imaging apparatus from the target position;
acquiring a shutter speed corresponding to the brightness and a movement speed corresponding to the shutter speed; and
causing, at the target position, the imaging apparatus to image the imaging target region with the shutter speed while causing the first moving object to move with the movement speed.
